(19) United States
(12) Patent Application Publication
(10) Pub. No.: US 2002/0108996 A1
(43) Pub. Date: Aug. 15, 2002

(54) Hand-held staple gun for non-metallic sheathed cable

(76) Inventors: Roger Dennis Cornett, Bowling Green, KY (US); David B. Fisher, Bowling Green, KY (US)

Correspondence Address: Joseph H. Golant, Jones, Day, Reavis & Pogue, 77 West Wacker Drive, Chicago, IL, 60601-1692, US

(21) Appl. No.: 09/784,542

(22) Filed: Feb. 15, 2001

(51) Int. Cl. B25C 5/02

(52) U.S. Cl. 227/132

(57) ABSTRACT

A staple gun is disclosed for one-handed operation, the staple gun being capable of dispensing insulated staples specifically designed to fasten non-metallic sheathed cable (Romex cable) to a substrate. The staple gun includes an alignment slot for the insulated staple formed by projections from a magazine and the inner surface of a front cover. A spring loaded follow block biases the staples and helps align an insulated staple so that it is positioned to be engaged by a driver.

### BACKGROUND OF THE INVENTION

1. Field of the Invention

The present invention relates to a hand-held staple gun and more particularly, to a hand-held staple gun to secure non-metallic sheathed cable to a substrate.

2. Description of the Related Art

Staple guns are well known devices as exemplified by two recently issued patents, U.S. Pat. No. 6,082,604 issued Jul. 4, 2000 and U.S. Pat. No. 5,931,364 issued Aug. 3, 1999, as well as the earlier patents cited as references in these patents. Staple guns generally include a housing, a pivotal handle attached to the housing, a driving spring, a driver, a staple magazine and a biasing member for bearing against a clip of staples. A major feature of these staple guns, sometimes referred to as staplers or fastening tools, is that they may be operated by one hand. The handle and housing are gripped in a hand-shake style and the handle and housing are squeezed together. During operation, the driving spring is biased until a predetermined point is reached by the handle. Then the spring is released to act on the driver which impacts on a staple. The impacted staple is then forced into a wooden base or substrate, often a 2 X 4 stud. Typically, a wire is resting on the substrate and the staple fastens the wire in place. Of course, staplers are also used to fasten insulation, ceiling tiles, roofing paper and carpeting, for example.

A staple is generally a U-shaped piece of metal. At times it is desirable to have an insulative element integrated with the metal such as shown in FIG. 2 of U.S. Pat. No. 5,735,444. Traditional staple guns have been limited to those dispensing staples with a maximum height of nine-sixteenth of an inch due to the limitations of the available energy from driving mechanisms and the available hand leverage attainable by a user. Insulated staples require greater staple height to attain penetration depths equivalent to non-insulated staples because of the added thickness of the insulative element positioned between the staple crown and the item to be fastened.

It is very desirable to fasten non-metallic sheathed cable (often referred to as “Romex cable”) in the same way that other cable is attached to a substrate. However, non-metallic sheathed cable is relatively large and requires a large insulated staple. For example, such a staple has a leg length of about fourteen-sixteenth of an inch and a bridge between the legs of greater than five-eighths of an inch. The insulated portion has an opening a half inch wide and greater than three-sixteenth of an inch high. A large staple requires a large driving force. Also insulated staples present alignment problems. Instead of a clip of identical metal staples, one next to another, the insulated staple is partially surrounded by a plastic element thereby causing the metal portion of one staple to be spaced from the metal portion of another staple by about a tenth of an inch.

### BRIEF SUMMARY OF THE INVENTION

The present invention has overcome the difficulties mentioned above. What is disclosed is a staple gun for dispensing insulated staples comprising in combination a housing including a front portion, a rear portion, a top portion, a bottom portion and a grip portion, a driver mounted to move generally linearly along the front portion of the housing for striking an insulated staple, a handle pivotally mounted to the housing operatively connected to the driver, a first biasing mechanism operatively connected to the driver for forcing the driver against the insulated staple, a magazine in the bottom portion of the housing for receiving a plurality of insulated staples, a second biasing mechanism for moving the plurality of insulated staples toward the front portion of the housing, and at least one projection in the front portion having a surface parallel to the movement of the driver for forming an alignment slot for the insulative portion of the insulated staple whereby the uninsulated portion of the insulated staple is aligned with the driver.

An object of the present invention is to provide a hand-held staple gun for dispensing insulated staples of a size to fasten non-metallic sheathed cable. Another aim of the present is to provide a staple gun which operatively aligns non-metallic sheathed cable size insulated staples. Another advantage of the present invention is to provide a staple gun for dispensing non-metallic sheathed cable size insulated staples which staple gun is manufactured and assembled much like existing staple guns. Still another aspect of the present invention is to provide a staple gun capable of one-handed operation and yet large enough to drive insulative staples to fasten non-metallic sheathed cable to a substrate.

A more complete understanding of the present invention and other objects, aspects, aims and advantages thereof will be gained from a consideration of the following description of the preferred embodiment read in conjunction with the accompanying drawing provided herein.

### BRIEF DESCRIPTION OF THE SEVERAL VIEWS OF THE DRAWING

FIG. 1 is a downward looking isometric view of a hand-held staple gun of the present invention.

FIG. 2 is an isometric exploded view of the staple gun of FIG. 1.

FIG. 3 is an elevational sectional view of the staple gun illustrated in FIGS. 1 and 2.

FIG. 4 is an isometric view of one embodiment of an insulated staple for a non-metallic sheathed cable, the cable being shown in phantom line.

FIG. 5 is a front elevational view of another embodiment of the insulated staple.

FIG. 6 is a side elevation view of the insulated staple shown in FIG. 5.

FIG. 7 is a bottom plan view of a portion of the staple gun shown in FIGS. 1-3, featuring the housing and the magazine.

FIG. 8 is an elevational sectional view of the housing and the magazine of the staple gun shown in FIGS. 1-3 and taken along line 8-8 of FIG. 7.

FIG. 9 is a front isometric view of the front portion of the magazine.

FIG. 10 is a top plan view of a rail assembly of the staple gun shown in FIGS. 1-3.

FIG. 11 is an elevational sectional view taken along line 11-11 of FIG. 10.

FIG. 12 is a side view of the nose cover for the staple gun shown in FIGS. 1-3.

FIG. 13 is a front view of the nose cover shown in FIG. 12.

FIG. 14 is a sectional plan view taken along the line 14-14 of FIG. 13.

FIG. 15 is an enlarged sectional plan view taken along the line 15-15 of FIG. 13.

FIG. 16 is an enlarged partial sectional view taken along line 16-16 of FIG. 13.

FIG. 17 is a front elevational view of the driver for the staple gun shown in FIGS. 1-3.

FIG. 18 is a side elevation view of the driver of FIG. 17.

FIG. 19 is a partial bottom plan view of the staple gun shown in FIGS. 1-3 and illustrating the alignment slot formed by the magazine and nose cover.

FIG. 20 is a partial bottom plan view illustrating an insulated staple in the alignment slot.

### DETAILED DESCRIPTION OF THE INVENTION

While the present invention is open to various modifications and alternative constructions, the preferred embodiment shown in the drawing will be described herein in detail. It is understood, however, that there is no intention to limit the invention to the particular form disclosed. On the contrary, the intention is to cover all modifications, equivalent structures and methods, and alternative constructions falling within the spirit and scope of the invention as expressed in the appended claims.

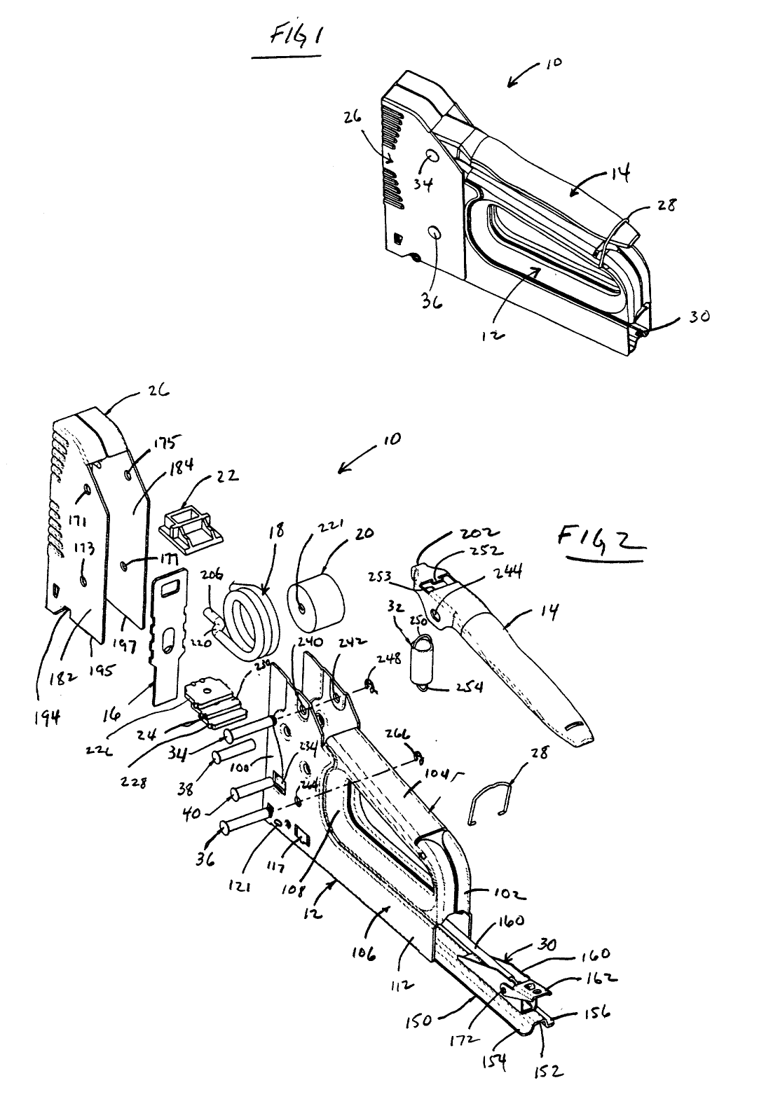

Referring now to FIGS. 1, 2 and 3, the various parts of the staple gun 10 is shown. The staple gun includes a metal housing 12, a metal handle 14, a driver 16, a torsion spring 18, a mandrel 20, a handle stop 22, a spring stop 24, a front cover 26, a retainer clip 28, a rail assembly 30, a return spring 32 and several pins 34, 36, 38 and 40 for holding the staple gun parts together.

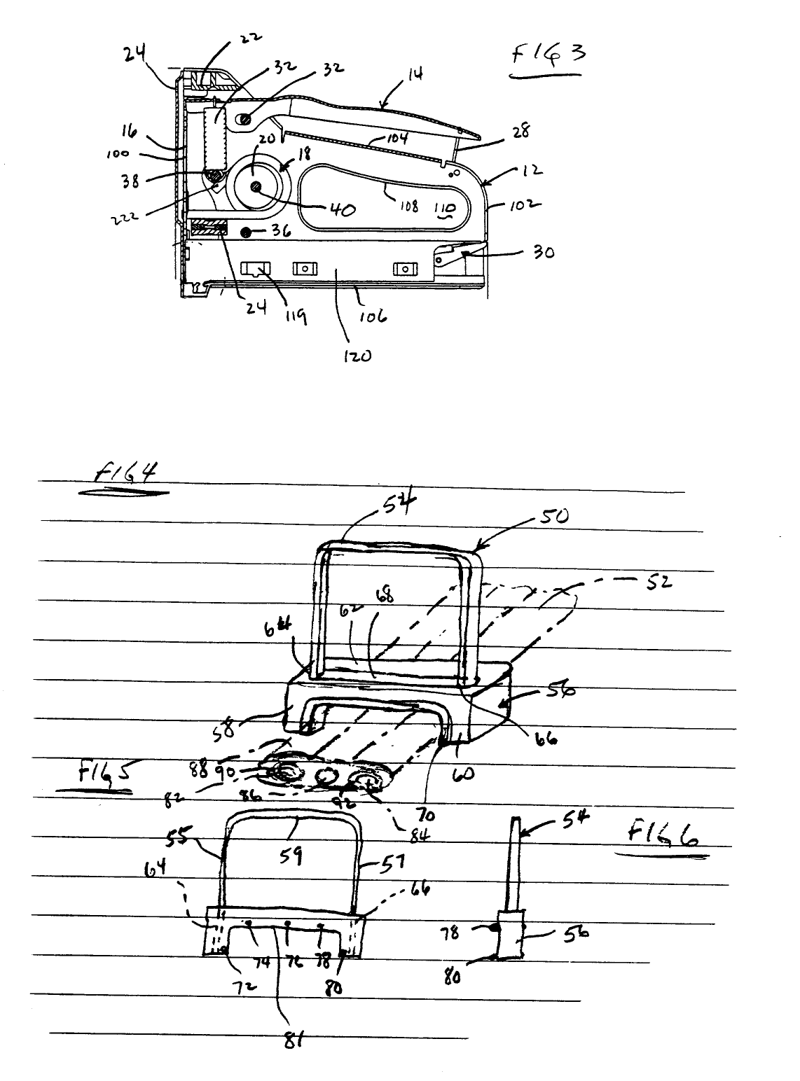

An important objective of the present invention is to provide a staple gun specifically constructed to drive insulated staples for securing non-metallic sheathed electrical cable. While the staple gun 10 has many similar features to existing smaller staple guns, it is larger to accommodate insulated staples, but it contains special features which allow the staple gun 10 to be operated in a manner closely analogous to smaller ordinary staple guns. Before further description of the staple gun, attention is directed to FIGS. 4, 5 and 6 which illustrate a standard insulated staple 50 in solid line and a non-metallic sheathed cable 52 drawn in phantom line. The insulated staple 50 has two portions, a traditional U-shaped metal portion 54 and a plastic insulated portion 56. The metal portion 54 is typically made of rounded rectangular steel wire where the wire has a height of about 0.04 inches and width of about 0.05 inches. The metal portion includes two legs 55, 57 and a base 59. The height of the staple is about 0.89 inches and the base is about 0.640 inches wide. The wire is C1018 steel. The insulated portion 56 is made of a suitable plastic, such as polypropylene, well known to those skilled in the art. The insulated portion 56 has a shortened U-shaped configuration, including two legs 58, 60 and a base 62. Two openings 64, 66 are provided through the insulated legs 58, 60 to accommodate the legs 55, 57 of the metal staple 54. A recess 68 is formed in the insulated base to accommodate the staple base 59 when the staple is inserted into a substrate on which the cable 52 is supported. Typically, the substrate is a wooden stud or joist. Each insulated portion has a trapezoidal shape and is about 0.71/0.73 inches wide, about 0.285 inches high and about 0.125 inches deep.

The insulated portion 56 includes a peripheral bumper 70 on the first and last staple of a multi-staple clip. Each of the staples are connected to one another through a series of nibs such as the nibs 72, 74, 76, 78, 80 spaced around the periphery 81 of the opening formed by the insulated portion 56. The nibs along with the bumper give each staple of a clip a specific depth dimension of about 0.15 inches and the nibs also act to connect one staple to the other until a staple is driven into a substrate at which time the nibs of the driven staple are also severed.

Non-metallic sheathed cable has two or more electrical conductors 82, 84 and a central ground conductor 86. These conductors are surrounded by an insulative outer shield 88 while each individual electrical conductor has its own insulation 90, 92.

An important object of the present invention is to provide a staple gun which has sufficient power to drive a large size insulated staple into a substrate and yet is hand held and hand operated. The problem is that the insulated staple is relatively large and requires a relatively large force to shoot it into a substrate. Further, the insulated staple creates alignment problems. The present invention recognizes and solves these problems with the result that the staple gun 10 may be handled in a manner analogous to the prior art smaller staple guns.

Referring now to FIGS. 2, 3 and 7, the housing 12 of the staple gun 10 may be divided into a front portion 100, a rear portion 102, a top portion 104, a bottom portion 106 and a grip portion 108. The grip portion 108 operates in conjunction with the handle 14 to allow an operator's hand to grip both the handle 14 with his/her palm while his/her fingers pass through an opening 110 formed in the grip portion.

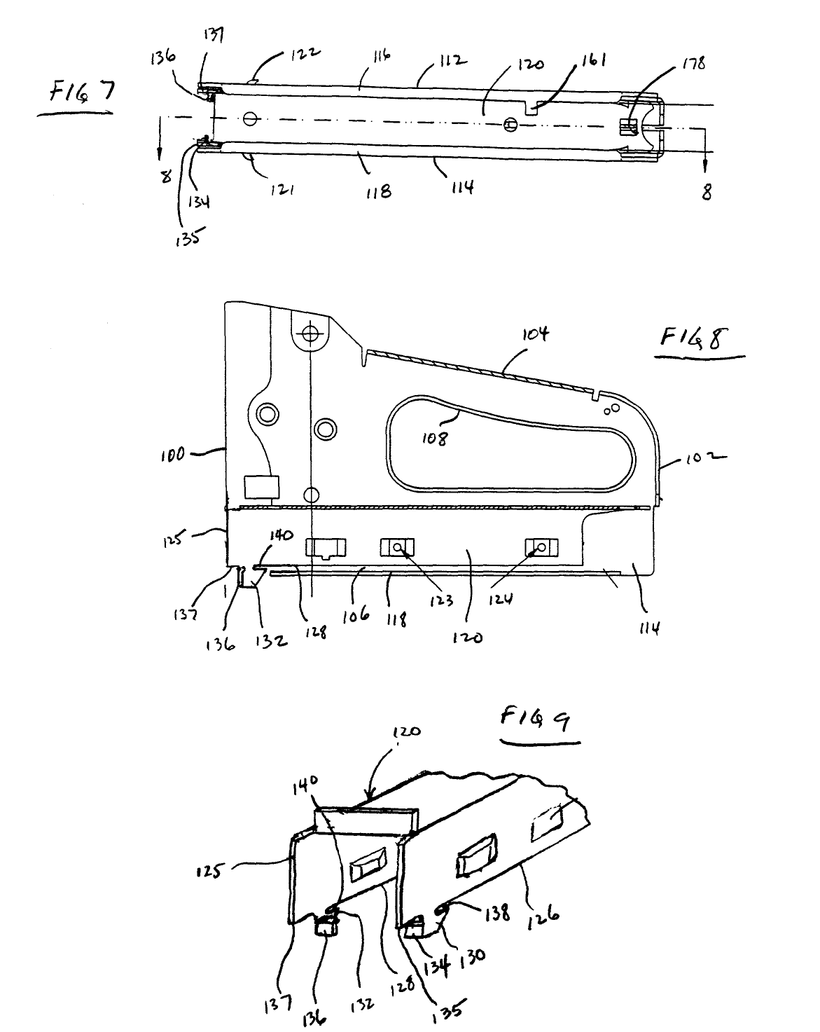

The housing may be made of a suitable metal such as 0.060 inch thick 1008/1010 steel and may be formed by stamping to the shape shown in the drawing. The metal is bent so as to provide a relatively smooth surface in the grip portion. The housing forms two spaced apart walls 112, 114 in the bottom portion 106 of the housing and each of the walls includes an inwardly directed short flange, such as the flanges 116, 11 8, FIG. 7. The housing also includes side openings, such as the opening 117, FIG. 2 for engaging a bulge 119 in a staple magazine 120, FIG. 3. The housing further includes side projections 121, 122 for aligning the front cover 26. These side projections protrude about 0.004 inches.

Mounted between the bottom walls 112, 114 is the generally channel shaped steel magazine 120, FIGS. 7 and 8. The magazine extends for most but not all of the length of the housing from the front portion 100 to the rear portion 102 and is attached in any suitable manner. Here, two welds connect each leg of magazine to a respective leg of the housing. See for example, the welds 123, 124. The purpose of the magazine is to receive a clip of staples (not shown). The front edge 125, FIGS. 8 and 9 of the magazine has a generally flat surface whereas the bottom edges 126 and 128 of the magazine are generally linear except near the front edge. Near the front edge, there are two depending projections 130, 132, extending about 0.267 inches. The projections have inwardly directed flanges 134, 136, respectively, and two oppositely disposed longitudinally extending side walls 135, 137 which, as will be explained later, help align the insulated staple to be driven into a substrate. The projections 130, 132 also form with the bottom edges 126, 128, two receiving slots 138, 140 which cooperate with the rail 30 to limit the forward position of the rail assembly. The receiving slots are about 0.093 inches wide.

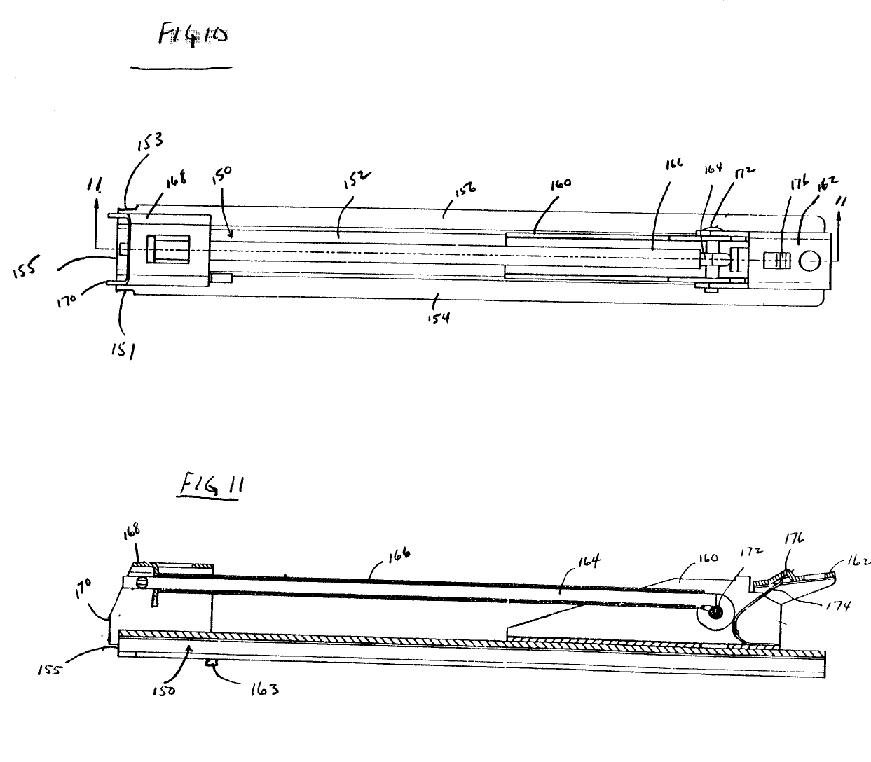

Referring now to FIGS. 2, 10 and 11, the rail assembly is shown in more detail. The rail assembly includes a base 150, having a head portion 152, two oppositely extending arms 154, 156 and a leading edge 155. Adjacent the leading edge 155 are two notches 151,153 which allow receipt of the rail assembly by the slots 138, 140, respectively. Mounted to the head portion is a latch support 160 to which is pivotally mounted a latch 162. The latch housing also terminates one end of a rod 164 around which is a coil spring 166. Attached to the opposite end of the rod 164 is a follow block 168. The follow block includes a front edge 170 whose purpose is to bear against the rear of the clip of staples. The follow block is biased forward by the spring 166 so that there is always a forward acting biasing force on the clip of staples. The latch 162 pivots around a rivet 172 and is biased to an upward position by a spring 174. When in a locked position, a projection 176 on the latch engages in an opening 178, FIG. 7 in the base of the magazine 120. The housing includes an arm 161, FIG. 7, positioned to limit sliding movement of the rail assembly by engaging a projection 163, FIG. 11 formed in the base 150.

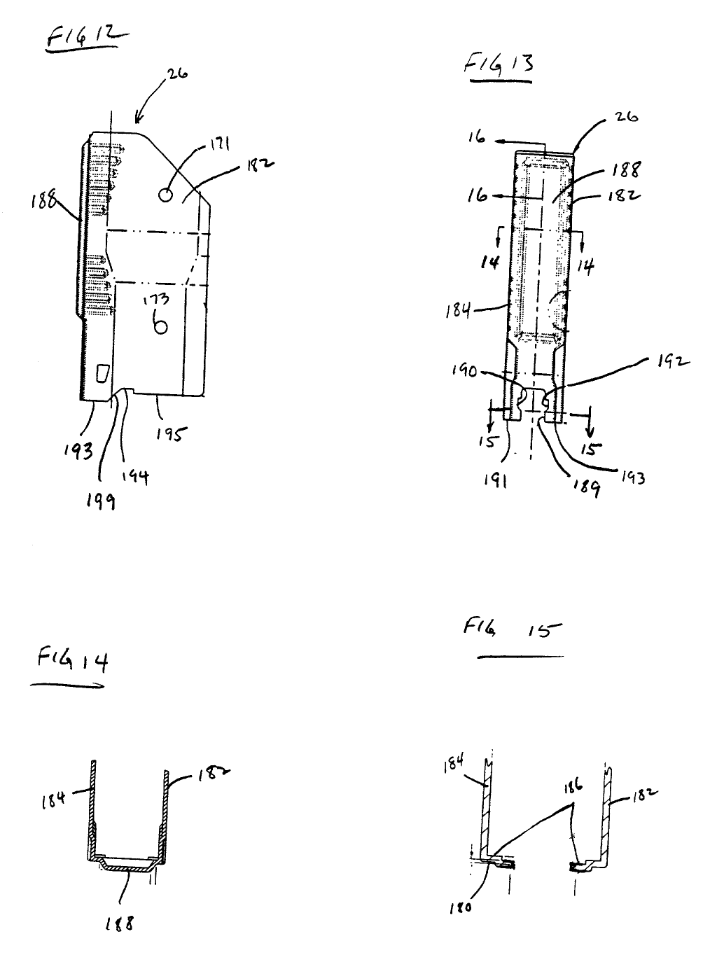

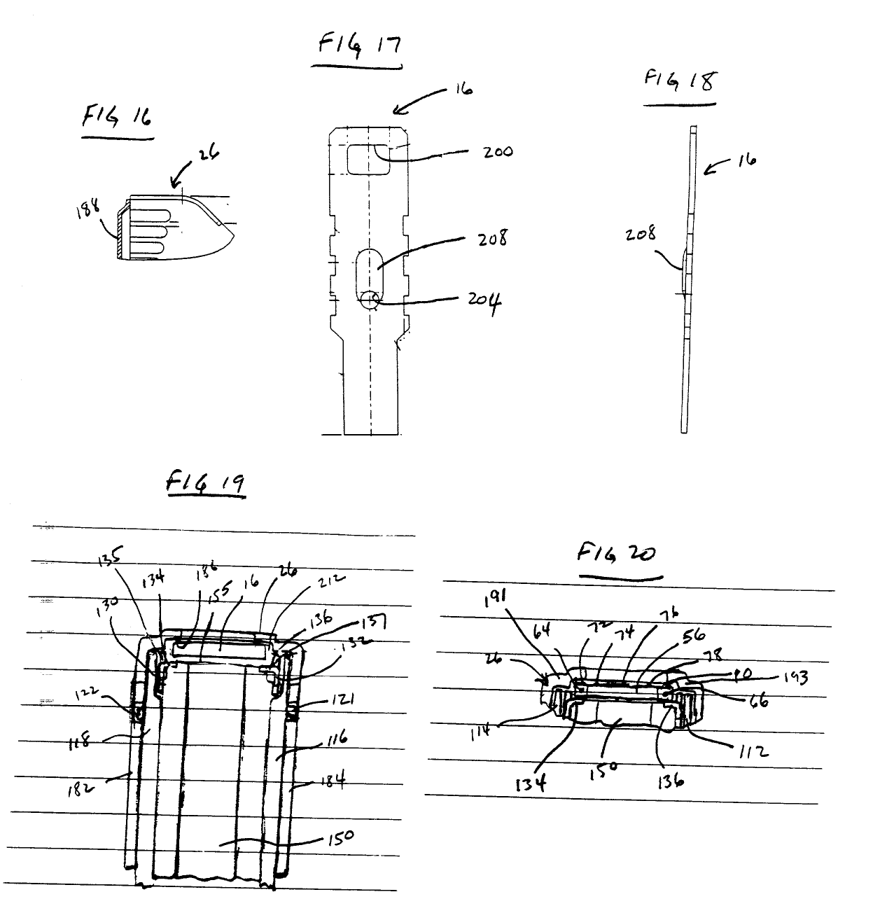

Referring now to FIGS. 2, 12-16, the nose cover 26 is shown in more detail. As with the housing, the nose cover may be made of any suitable material such as 0.060 inch thick 1008/1010 steel. The nose cover is formed by any suitable process, such as metal stamping. The front cover has a generally U-shape profile as shown in FIGS. 14 and 15, and each leg 182, 184 has two openings 171, 173, 175, 177, FIG. 2, for receiving fasteners. The U-shape nose cover also includes a front base portion 180 spanning the legs. The front portion 180 includes an inner surface 186 which forms a raceway for supporting and guiding the driver 16 as it moves linearly along the front portion of the housing. The nose cover also includes a bulbous projection 188 for accommodating the torsion spring 118 during movement of one of its arms when the staple gun is operated. The nose cover further includes a front cut-out 189 having a head shape front view as shown in FIG. 13. The head shape includes two ears 190, 192 for accommodating the projecting nibs on the staples and allowing the lead staple to move as far forward as possible. Each of the nose cover legs 182, 184 includes a cut-out, such as the cut-out 194 for engaging the projections 121, 122, FIG. 7 of the housing and allow positive alignment and locking with the housing. Forward bottom edges 191, 193 allow the nose cover to straddle a cable and support the staple gun on a substrate during a stapling operation. It is noted that the forward bottom edges 191, 193 are about 0.170 inches lower than rearward bottom edges 195, 197, FIGS. 2 and 12. The depth of the cut-out 194 is about 0.170 inches and the slanted surfaces, such as a surface 199 is located 135° from a reference horizontal, a line coinciding with the edge 193.

Referring now to FIGS. 17 and 18, the driver 16 is illustrated in detail and comprises a strip of spring steel SAE 1074. The strip is approximately 3.652 inches long and approximately 0.102 inches in thickness. The driver includes a top opening 200 for receiving a nose 202, FIG. 2 of the handle 14. When the handle is pivoted downwardly toward the housing, the handle nose 202 moves in the opposite direction causing the driver to be lifted. In approximately the middle portion of the driver, an opening 204 is provided to receive one arm 206 of the torsion spring 18. When the handle nose lifts the driver, the driver in turn lifts the arm of the torsion spring. Lifting of the torsion spring arm 206 biases the arm so that when the handle nose disengages the driver, the arm of the torsion spring will return to a horizontal position (as shown in FIG. 3) thereby forcing the driver back to its original position during which it impacts a staple with a force sufficient to drive the staple into a substrate.

The opening 200 is approximately 0.35 inches in height and approximately 0.50 inches in width. The opening 204 is approximately 0.215 inches in diameter. Immediately above the second opening 204 is a driver bulge 208. The length of the bulge is about 0.7 inches long and approximately 0.32 inches in width.

As already mentioned, a major feature of the staple gun 10 is its ability to align and drive the relatively large insulated staple used for securing non-metallic sheathed cable. The staple gun 10 is constructed to form an alignment slot indicated by the numeral 212, FIG. 19. 15 This slot is generally rectangular in shape, about 0.127 to 0.145 inches in width, and is formed by the inner surface 186 of the nose cover 26, the two inwardly directed flanges 134, 136 of the magazine, the leading edge 155 of the rail assembly base 150 and the side walls 135, 137. At the same time, the leading edge 170, FIG. 11 of the follow block 168 bears against the last staple in the staple clip. This combination aligns the insulated portion 56, FIG. 20 of each staple so as to maintain it approximately perpendicular to the substrate surface into which the staple is to be driven as well as to the cable to be fastened. With the insulated portion 56 of the staple aligned and retained, the wire portion 54 of the staple is also aligned in relation to the driver 16.

The position and alignment of the insulated portion of the staple is shown in FIG. 20. It is this alignment feature as well as the driver and torsion spring combination which allows the staple gun to be operated in much the same way as an ordinary smaller cable staple gun, one that uses exclusively metal staples without electrically insulated portions.

Referring once again to FIGS. 2 and 3, the torsion spring 18 is made of 0.197 diameter spring wire having 2.611 coils. The spring rate is about 3.34 inch-pounds/degree of deflection. In operation, it is expected that the arm 206 of the torsion spring will be deflected approximately 42.9° which creates approximately 143.3 inch-pounds of torque to act upon the driver once the handle releases the driver. The inner diameter of the coiled torsion spring is approximately 1.125 inches and the arm 206 beyond the bend 220 extends into the opening 204 of the driver approximately 0.400 inches. The opposing arm 222 of the torsion spring is at an angle of approximately 130° from a reference vertical line when the arm 206 is at approximately 90° from that same reference when at rest.

Fitted within the central opening of the torsion spring is the mandrel 20. The mandrel has an outer dimension of approximately 1.000 inch and a central opening 221 of approximately 0.240 inches. The central opening allows the mandrel and thereby the torsion spring to be mounted to the housing 12 by the pin 38. The mandrel may be made of any suitable material, such as SAE 1008/1010 steel.

The force of the returning torsion spring arm 206 is absorbed by the stop 24 which comprises a sandwich of three tabs, two steel tabs 226, 228 around a resilient tab 230. The steel tabs may have a thickness of approximately 0.118 inches and may be made of SAE 1008/1010 steel. The resilient tab 230 may be of the same thickness but of nitrile or Buna rubber. The tabs are mounted to the housing 12 by fitting the tabs into housing side openings, such as the side opening 234. Dimensionally the tabs are approximately 1.030 inches in width and about 0.82 inches in length.

The handle 14 is mounted to the housing 12 by the pin 34 which is captured through housing side openings 240, 242, FIG. 2 and handle side openings, such as the opening 244. The handle openings are oblong to allow the handle to slip out of contact with the driver. As can now be appreciated pivoting of the handle 14 downwardly around the pin 34 causes the handle nose 202 to move in the opposite direction. The pin 34 is captured by a retaining ring 248. Mounted between the handle nose 202 and the side openings of the handle is an upper end 250 of the coil return spring 32. The coil spring upper end 250 engages a tongue 252 formed in a cut-out 253 in the handle. A coil spring bottom end 254 is captured by the pin 38. The pin 40 captures the mandrel 20. The pin 38 also engages the torsion spring arm 222 preventing movement. The lowermost pin 36 helps to mount the nose cover 26 to the housing 12 through nose cover openings 173, 175 and the housing openings such as the opening 264. A retainer ring 266 is then used to affix the pin 36 into position. The return spring is made of steel wire having a diameter of about 0.0472 inches, the outside diameter of the coil is about 0.5 inches and there are 6.25 turns. The spring rate is approximately 12.3 pounds per inch.

The handle stop 22 is mounted in the upper end of the nose cover 26 and provides an abutment to the handle nose 202. The handle stop may be made of any suitable material such as high impact ABS plastic. The width of the handle stop is approximately 1.017 inches and its length is approximately 1.143 inches. The pins 34, 36, 38 and 40 may be made of any suitable material such as SAE 1008 steel. The two pins 38 and 40 pass through the housing 12 but not through the nose cover 26. The pins 34 and 36, however, pass through both the nose cover 26 and the housing 12 and have reduced diameter ends for receiving the retainer clips 248 and 266, respectively.

The handle clip 28 is provided to constrain the handle 14 in a lowered position during storage and shipment so that the staple gun assumes a reduced profile as shown in FIGS. 1 and 3.

In operation the latch 162 is depressed to allow the rail assembly 30 to be extracted from the housing 12 until the stop projection 163 on the rail engages the arm 161 of the housing. A clip of insulated staples is then inserted into the magazine 120 while the staple gun is held in an upside down position as shown in FIG. 19. The rail assembly is then pushed back into the housing until the latch 162 locks itself to the magazine 120. In this position, the leading edge 170 of the follow block provides a biasing force on the clip of staples biasing the staples toward the front portion of the staple gun. The handle clip 28 is then rotated out of the way to allow the handle to extend upwardly under the influence of the return spring 32. The staple gun is then mounted atop a non-metallic sheathed cable where the nose cover front cut-out 189 straddles the cable. At this time the staple clip is biased against the driver 16. To dispense a staple, the handle is rotated back toward the housing 12 causing the handle nose 202 to rotate upwardly toward the handle stop 22. The handle hose is engaged with the driver opening 200 causing the driver to be raised upwardly at the same time. Once the driver 16 is raised out of the way the lead staple of the clip advances to the inner surface 186 of the front cover. Because the arm 206 of the torsion spring 18 is engaged with the opening 204 of the driver, it will also be pivoted upwardly so as to create a substantial potential downward force on the driver when the handle nose slips out of engagement with the driver opening 200. When this happens, the strongly biased arm 206 of the torsion spring 18 immediately returns to its horizontal position as shown in FIG. 3 providing a strong force on the driver to cause it to impact strongly on the metal portion of the insulated staple causing it to drive the staple into a substrate.

The alignment slot space 212 formed by the inner surface 186 of the nose cover, the inwardly directing flanges 134, 136 of the magazine, the leading edge 155 of the rail assembly and the longitudinally directed sides of the magazine walls 135, 137, causes the insulated portion of the staple to be maintained in alignment to allow the driver 16 to make solid contact with the wire portion 54 of the staple and to drive the staple into the substrate and against the cable. As this is being done, the driver has a sufficient force to separate the lead staple from the remaining staples of the clip by shearing the connecting nibs.

What is achieved is a hand held and hand operated staple gun especially designed to handle the large insulated staples used to secure non-metallic sheathed cable to substrates. The staple gun 10 is able to be handled by an operator in a generally traditional fashion and the staple gun itself is easy and relatively inexpensive to manufacture since it is built generally along the lines of existing staple guns.

The specification describes in detail an embodiment of the present invention. Other modifications and variations will under the doctrine of equivalents come within the scope of the appended claims. For example, changing dimensions, spring rates or design features of the housing or nose cover or rail assembly are considered equivalent structures. Still other alternatives will also be equivalent as will many new technologies. There is no desire or intention here to limit in any way the application of the doctrine of equivalents.

1. A staple gun for dispensing insulated staples comprising in combination:
a housing including a front portion, a rear portion, a top portion, a bottom portion and a grip portion;
a driver mounted to move generally linearly in relation to the front portion of said housing for striking an insulated staple;
a handle pivotally mounted to said housing operatively connected to said driver;
a first biasing mechanism operatively connected to said driver for forcing said driver against the insulated staple;
a magazine in said bottom portion of said housing for receiving a plurality of insulated staples;
a second biasing mechanism for moving the plurality of insulated staples toward said front portion of said housing; and
a least one projection having a surface parallel to movement of said driver for forming an alignment slot for the insulative portion of the insulated staple connected to said housing whereby the uninsulated portion of the insulated staple is aligned with said driver.

2. A staple gun as claimed in claim 1 including:
a front cover mounted to the front portion of said housing;
said front cover having an inner surface for guiding said driver; and
said projection having a surface spaced from and parallel to said inner surface of said front cover.

3. A staple gun as claimed in claim 1 wherein:
said handle includes a nose portion for engaging said driver and for moving said driver in a first direction; and including:
a handle stop mounted to said housing for limiting the pivotal movement of said handle.

4. A staple gun as claimed in claim 1 including:
a first biasing mechanism stop for limiting movement of said first biasing mechanism.

5. A staple gun as claimed in claim 1 wherein:
said first biasing mechanism includes a torsion spring.

6. A staple gun as claimed in claim 5 wherein:
said first biasing mechanism includes a mandrel.

7. A staple gun as claimed in claim 1 wherein:
said driver is a strip of metal with two spaced apart openings, a first opening for receiving said handle and a second opening for receiving said first biasing mechanism.

8. A staple gun as claimed in claim 1 wherein:
said second biasing mechanism includes a spring and a follow block.

9. A staple gun as claimed in claim 1 including:
a front cover mounted to the front portion of said housing and wherein:
said housing and said magazine have aligned openings.

10. A staple gun as claimed in claim 1 including:
a rail assembly including said second biasing mechanism.

11. A staple gun as claimed in claim 1 including:
a front cover mounted to the front portion of said housing;
said handle and said grip portion of said housing cooperate to allow one handed operation of the staple gun;
said first biasing mechanism includes a torsion spring;
said second biasing mechanism includes a coil spring and a follow block; and
said at least one projection includes two projections depending from said magazine and forming with an inside surface of said front cover the alignment slot for the insulative portion of the insulated staple.

12. A staple gun as claimed in claim 1 including:
an opening in said front cover to accommodate the projections on the insulated staple.
